(19) United States
(12) Patent Application Publication
(10) Pub. No.: US 2008/0174427 A1
(43) Pub. Date: Jul. 24, 2008

(54) INTELLIGENT AUTOMATED METHOD FOR SECURING CONFIDENTIAL AND SENSITIVE INFORMATION DISPLAYED ON A COMPUTER MONITOR

(76) Inventors: Dwip N. Banerjee, Austin, TX (US); Ranadip Das, Kolkata (IN); Sandeep Ramesh Patil, Pune (IN); Venkat Venkatsubra, Austin, TX (US)

Correspondence Address: IBM CORP (YA);C/O YEE & ASSOCIATES PC, P.O. BOX 802333, DALLAS, TX, 75380, US

(21) Appl. No.: 11/625,294

(22) Filed: Jan. 20, 2007

(51) Int. Cl. G08B 13/00

(52) U.S. Cl. 340/541

(57) ABSTRACT

A computer implemented method, data processing system, and computer program product for securing confidential and sensitive information displayed on a computer monitor. Confidential information is displayed in an application on a computer, wherein the application is registered in a registration list comprising a list of all applications containing confidential information. A monitoring device is used to monitor an area around a user of the computer for a possible intruder. Responsive to detecting a possible intruder, an action for securing the confidential information displayed on the computer is identified based on the applications specified in the registration list. The action is then executed.

### BACKGROUND OF THE INVENTION

1. Field of the Invention

The present invention relates generally to an improved data processing system, and in particular to an intelligent automated method and system for securing confidential and sensitive information displayed on a computer monitor.

2. Description of the Related Art

In many situations, computer users access and update confidential or sensitive information in a personal or organizational setting using computer based applications. This confidential or sensitive information may include confidential emails, blueprints, project reports, company statistics/charts, chat communications via Instant Messenger, personal medical reports, and the like. When such information is accessed, it is necessary to protect the information to make sure it is not leaked or shared by any means. Protecting the information can be difficult in today's work environments which often comprise open work spaces. An open work space may include any space in which more than one person is working in a room. For example, open work spaces in many corporate offices typically comprise a large area in which employees are stationed within individual cubicles, rather than within individual or separate offices. In such open work space environments, there are many times in which employees visit or pass by other employees at their desks or cubicles. During this period, any confidential or sensitive information displayed on an employee's computer monitor when another employee passes by is exposed, which may lead to a leak of the confidential information. Thus, there is a strong need to protect the confidential or sensitive information from trespassers and other undesired audience (possible intruders) who pass by a user's computer when the user is working on confidential data which is displayed on the computer monitor.

Consider the following commonly encountered scenario in which an employee is viewing a confidential report on the employee's computer via a document viewer or related application. During this period, one of the employee's colleagues approaches the employee's desk from behind. At this point of time, the employee has to immediately realize that the employee's computer monitor is displaying confidential and sensitive information, and then promptly minimize, switch, or close the open application. Otherwise, if the confidential and sensitive information remains displayed on the monitor, the employee may unintentionally leak the information to the colleague.

The response the employee must perform in the previous scenario to protect the confidential information is currently a manual process. Thus, in addition to the discomfort a user may typically feel when startled by someone approaching from behind, the user must also perform a manual process quickly in order protect the confidential information.

A solution available in the market today makes use of “desktop mirrors”, also called “rearview mirrors for computer monitors”. These rearview mirrors are convex mirrors, generally fixed on computer monitors, which allow a user to view activity occurring behind the user. Users may use these rearview mirrors to keep an eye on their surroundings, and when the user notices someone approaching in the mirror, the user may minimize, switch, or close the application displaying confidential or sensitive information. While the rearview mirrors provide a mechanism for a user to be notified when someone approaches from behind, the use of these mirrors only gives the user a lead time to take action, but the process of minimizing, switching, or closing the application displaying confidential or sensitive information still remains a manual process. In addition, apart from the overhead of requiring a user to continuously monitor the rearview mirror, the current solution is not full-proof, as there are chances for the user to miss detecting a possible intruder if the user does not monitor the rearview mirror carefully.

### SUMMARY OF THE INVENTION

The illustrative embodiments provide a computer implemented method, data processing system, and computer program product for securing confidential and sensitive information displayed on a computer monitor. Confidential information is displayed in an application on a computer, wherein the application is registered in a registration list comprising a list of all applications containing confidential information. A monitoring device is used to monitor an area around a user of the computer for a possible intruder. Responsive to detecting a possible intruder, an action for securing the confidential information displayed on the computer is identified based on the applications specified in the registration list. The action is then executed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a human detection system in which the illustrative embodiments may be implemented;

FIG. 2 is a block diagram of a data processing system in which the illustrative embodiments may be implemented;

FIG. 3 is a block diagram of a software architecture with which the illustrative embodiments may be implemented;

FIG. 4 is a flowchart of a process for configuring an action to be taken when an event is detected in accordance with the illustrative embodiments;

FIG. 5 is a flowchart of a process for securing confidential and sensitive information displayed on a computer monitor in accordance with the illustrative embodiments; and

FIG. 6 is a flowchart of a process for polling the activity of registered applications in accordance with the illustrative embodiments.

### DETAILED DESCRIPTION OF THE PREFERRED EMBODIMENT

The illustrative embodiments provide an intelligent automated method and system for securing confidential and sensitive information displayed on a computer monitor. The illustrative embodiments provide an automated solution to the existing manual processes for securing confidential information. With the illustrative embodiments, no interaction is required by the user to secure the confidential information, since configurable actions may automatically be performed to protect the confidential or sensitive information being displayed on the computer monitor. The automated solution in the illustrative embodiments also eliminates the user overhead involved in the existing manual processes, as well as provides a full proof mechanism for protecting confidential information.

During the time a user has confidential or sensitive information displayed on the user's computer monitor, the illustrative embodiments continuously monitor the activity in an area around the user. The activity may be monitored using an image capturing device or a motion detector, such as a digital camera or an infrared sensor. Human detection software may use the information obtained from the device or detector to identify the occurrence of an event (e.g., motion of a person approaching the user) in an area around the user. When the human detection software detects an event, a predefined and configurable action is immediately triggered. The configurable action may comprise any action to secure the confidential or sensitive information, such as automatically minimizing, closing, or switching the applications that are displaying confidential or sensitive information. In this manner, if a possible intruder in the form of a trespasser or colleague approaches the user's desk or computer, the intruder will not be able to view the confidential or sensitive information displayed on the user's monitor.

In addition, the illustrative embodiments also solve the problem of password guessing using “shoulder surfing”. Shoulder surfing is a well known problem in the security domain and comprises the act of looking over a computer user's shoulder and watching the user as the user types in a password. As the illustrative embodiments prevent an intruder from viewing confidential or sensitive information displayed on a user's monitor, the illustrative embodiments may also prevent password guessing using shoulder surfing.

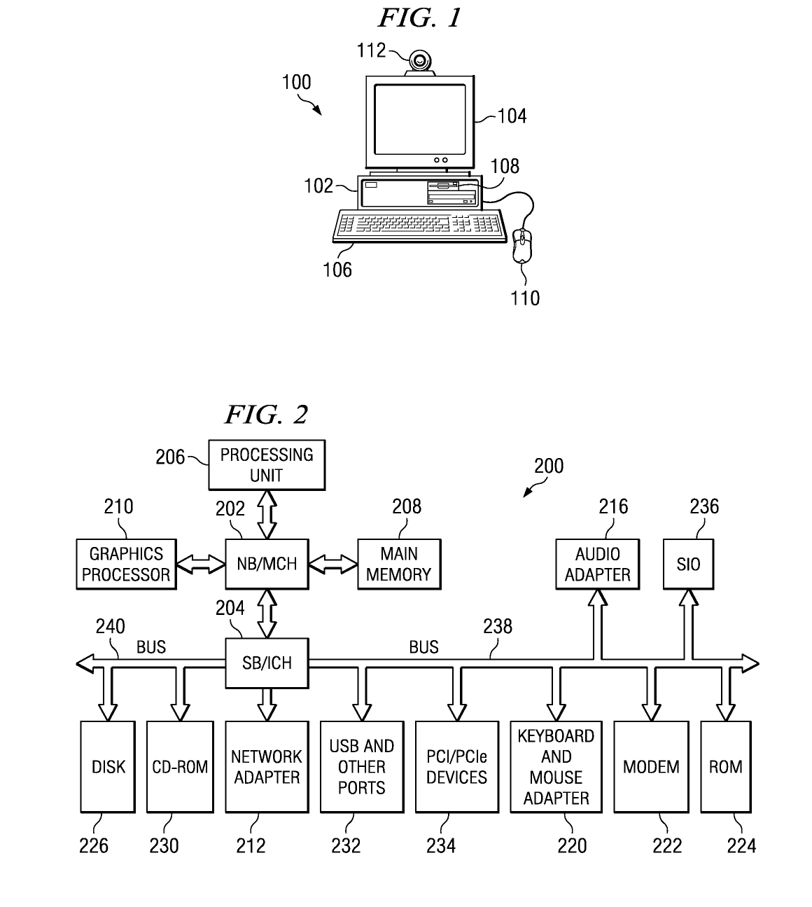

FIG. 1 is a high level block diagram of exemplary components with which the illustrative embodiments may be implemented. In this illustrative example, computer system 100 includes system unit 102, video display terminal 104, keyboard 106, storage devices 108, which may include floppy drives and other types of permanent and removable storage media, and mouse 110. Additional input devices may be included with personal computer system 100. Examples of additional input devices include a joystick, touchpad, touch screen, trackball, microphone, and the like. Computer system 100 also includes monitoring device 112 for detecting or capturing human movement. Examples of monitoring device 112 include a digital camera or an infrared sensor. In this particular example, monitoring device 112 is installed on video display terminal 104. However, monitoring device 112 may be placed at any location on or around computer system 100 to allow monitoring device 112 to detect movement within or capture images of the area around the computer user and computer system 100.

Computer 100 may be any suitable computer, such as an IBM® eServer computer or IntelliStation® computer, which are products of International Business Machines Corporation, located in Armonk, N.Y. Although the depicted representation shows a personal computer, other embodiments may be implemented in other types of data processing systems. For example, other embodiments may be implemented in a laptop computer, personal digital assistant, telephone device, and the like.

FIG. 2 is a block diagram of a data processing system is shown in which illustrative embodiments may be implemented. Data processing system 200 is an example of a computer, such as computer system 100 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

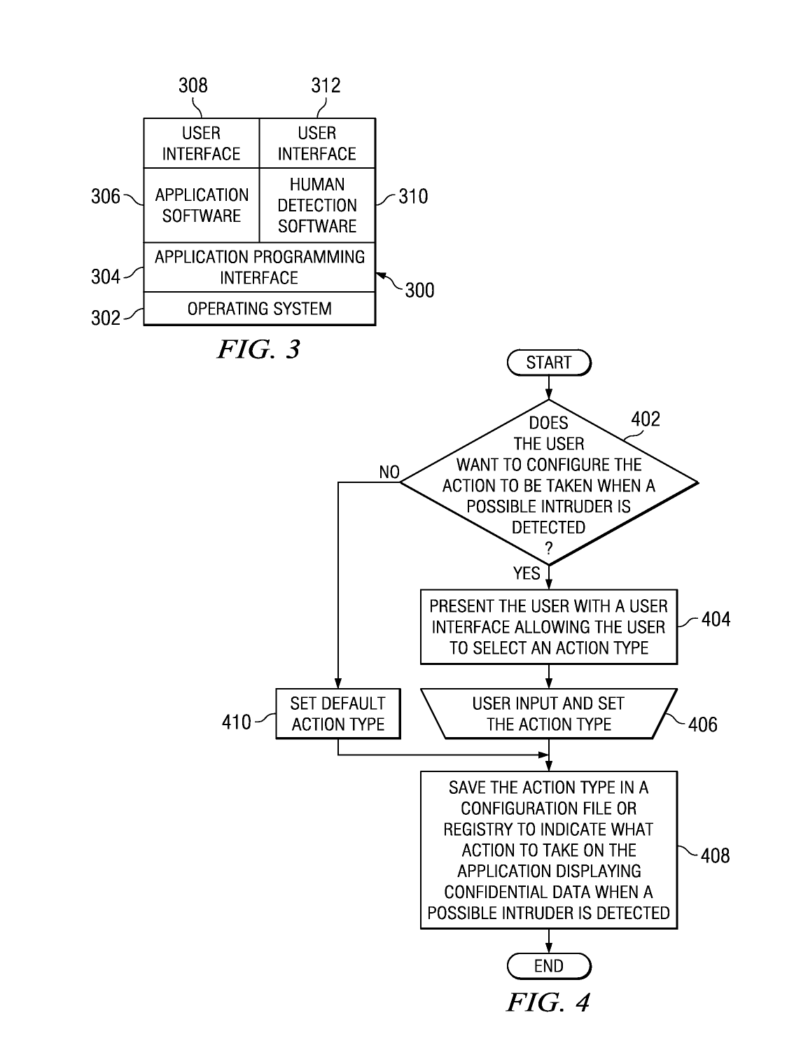

FIG. 3 is a block diagram of an exemplary software architecture with which the illustrative embodiments may be implemented. Software within software architecture 300 may reside in computer readable media in operation within computer system 100. At the lowest level, operating system 302 is utilized to provide high-level functionality to the user and to other software. Such an operating system typically includes a basic input output system (BIOS). Application programming interface (API) 304 allows the user of the system, an individual, or a software routine to invoke system capabilities using a standard consistent interface without concern for how the particular functionality is implemented. Application software 306 represents any number of software applications designed to react to data to provide the desired functionality the user seeks. Application software 306 may provide information to the user via user interface 308. Applications at this level may include those necessary to handle data, video, graphics, photos, or text of a confidential or sensitive nature.

Software architecture 300 also comprises human detection software 310. Human detection software 310, together with monitoring device 112 in FIG. 1, allows for the automation of securing confidential or sensitive information on a user's computer monitor. Human detection software 310, via user interface 312, allows a user to indicate that a particular instance of an application is displaying confidential information on the user's monitor. Thus, user interface 312 is provided to the user so that the user may register the instance of the application with human detection software 310 as displaying confidential or sensitive information. To register an application, the user may input the process identifier (PID) of the application instance into user interface 308. A user may obtain the PID of the application instance in various ways. For example, the human detection software 310 may maintain a list of all running applications on the user's desktop and present the user with the list. The user may select the applications which are displaying confidential data from that list. The human detection software 310 will make note of all of the user selected applications from that list, obtain their PID using API 304 provided by operating system 302, and then monitor these applications. In another example, the user may obtain the PID of the application instance by using basic commands or tools provided by the operating system 302 in a manner similar to using the Windows Task Manager utility in Microsoft Windows XP to view the PID of the running applications and processes. If the user inputs the process name of the application instance displaying the confidential information during the registration process, human detection software 310 may determine the process ID of the application instance using the API 304 provided by operating system 302. Operating system 302 may return the process ID of the processes which are active on the desktop. When human detection software 310 obtains the process ID, human detection software 310 may then add the application instance represented by the process ID to an internally maintained list of application instances that are registered as displaying confidential or sensitive information. This list may be retained in a file or registry or a local database.

In addition, human detection software 310 also provides user interface 312 to the user to allow for configuring the action that will be taken when an event, such as changes or movement occurring in the area around the user, is detected. Such actions may include, but are not limited to, minimizing the registered applications displaying the confidential or sensitive information to the desktop, closing the registered applications displaying the confidential or sensitive information to the desktop, wherein changes made to the information may be automatically saved, switching the registered applications displaying the confidential or sensitive information to the background and placing another application in foreground, or auto-locking the desktop and starting a default screen saver.

Human detection software 310 also may comprise built-in digital image processing capabilities. Alternatively, human detection software 310 may make use of software already present in the data processing system which has such capabilities. For example, if a digital camera is installed as the monitoring device on the user's computer monitor, human detection software 310 may use the digital camera video or images being captured live to immediately detect changes or movement in the area around the user. Any algorithm may be used by human detection software 310 to identify changes or movement in the digital video or images. For example, one simple algorithm comprises allowing the digital camera to continuously capture video of the area around the user. At a predefined time interval (e.g., every “t” seconds), the digital camera takes a digital image of the video being captured and saves the image. Human detection software 310 then compares the latest captured digital image with the image captured “t” seconds earlier, using any known image and pixel comparison technique. If the images are identical, human detection software 310 determines that no movement has occurred. However, if the images are different, human detection software 310 determines that movement has occurred, and an automated action is taken to secure the confidential information on the user's computer monitor. It should be noted that decreasing the time interval “t” may provide more accurate detection results.

Infrared sensors may be used as an alternative to using a digital camera to detect movement. Infrared sensors are widely used today as motion detectors. Current infrared sensor-based solutions and software provide facilities that allow the sensors to be easily integrated with other software, such as human detection software 310. Alternatively, human detection software 310 may itself comprise infrared sensor processing capabilities for detecting movement. Thus, human detection software 310 should have the capability of identifying any changes or movement occurring in the area around the user, either by using existing digital image processing software or techniques or infrared sensors.

When human detection software 310 identifies any changes or movement occurring in the area around the user via a digital camera or infrared sensor, this identification triggers human detection software 310 to perform the action, selected by the user, on the registered applications. Human detection software 310 may use API 304 provided by operating system 302 to implement the action, such as minimizing, closing, or switching the application. The application's PID is used as the input parameter to identify the registered applications on which to take action.

Human detection software 310 provides user interface 312 which allows users to select the type of action (e.g., minimize, close, switch, etc.) to be taken on the application displaying the confidential or sensitive information when a possible intruder is detected by the software. If the user does not select a particular action, human detection software 310 may assign a default action to the application.

3 In one embodiment, human detection software 310 may be implemented as an application independent from other software in the computer system. In another embodiment, human detection software 310 may be comprised of various software applications, each application performing one or more sub-tasks of the solution for securing confidential or sensitive information on a user's computer monitor.

FIG. 4 is a flowchart of a process for configuring an action to be taken when an event is detected in accordance with the illustrative embodiments. In particular, the process described in FIG. 4 provides a user interface which allows the user to configure the type of action that will be taken when human detection software 310 in FIG. 3 detects an event.

The process begins with determining whether the user wants to configure an action to be taken upon the detection of a possible intruder (step 402). This determination may be made at a time when the human detection software is installed, or at a later time when the user wants to view of change the configuration. If the user wants to configure an action to be taken (‘yes’ output of step 402), the user is presented with a user interface such as a configuration panel which prompts the user to select an option indicating the action to be taken when a possible intruder is detected (step 404). The types of actions may include minimizing all of the applications registered to be working with confidential information, closing (with an auto-save feature) all of the applications registered to be working with confidential information, switching the applications registered to be working with confidential to the desktop background and moving another application to the foreground, or auto-locking the desktop and starting a default screen saver.

A configuration process or component in the human detection software receives the user input and sets the action type to be taken when a possible intruder is detected (step 406). The configuration process or component in the human detection software then saves the action type in a configuration file or registry (step 408), with the process terminating thereafter. The saved action type may later be used to indicate the action that will be taken on any application displaying confidential data when a possible intruder is detected.

Turning back to step 402, if the user does not want to configure an action to be taken (‘no’ output of step 402), the configuration process or component in the human detection software sets a default action type (e.g., minimize all applications registered to be working with confidential information) to be taken when a possible intruder is detected (step 410). The process continues to step 408, where the default action type is saved in a configuration file or registry. The process terminates thereafter.

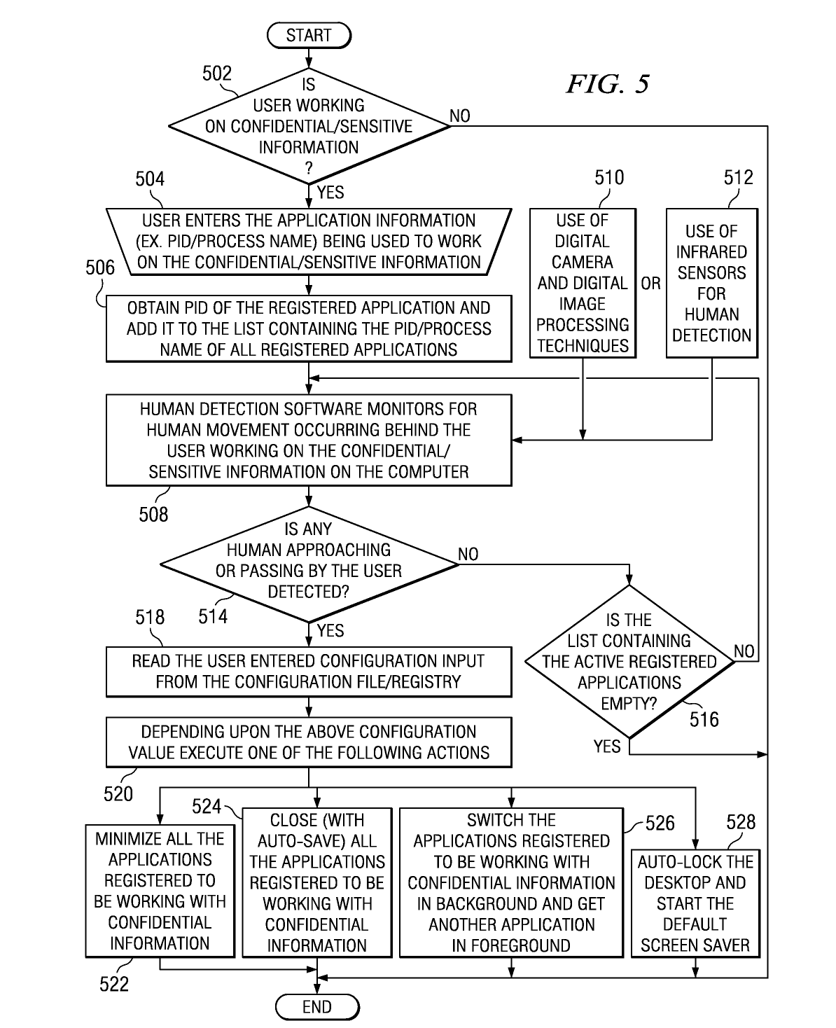

FIG. 5 is a flowchart of a process for securing confidential and sensitive information displayed on a computer monitor in accordance with the illustrative embodiments. The process begins with the user making a determination whether the user is working on confidential information (step 502). While the user makes this determination, applications displaying the confidential data may also assist the user in determining if the document is confidential. For example, a Lotus Notes® client can inform a user that a document or email was marked “confidential” by the originator.

If the user is not working on confidential information (‘no’ output of step 502), the process terminates. However, if the user is working on confidential information (‘yes’ output of step 502), the user inputs information identifying the application instance being worked on, such as the application process ID or the process name (step 504). An initialization or registration component of the human detection software then receives the user input of the reported application instance and adds the application instance to a list containing the PIDs or process names of all of the registered application instances (i.e., application instances displaying confidential information) (step 506).

Next, the human detection software monitors for human movement occurring around the user who is working on confidential information on a computer (step 508). The human detection software may monitor the area around the user using a digital camera and digital image processing techniques (step 510), or using infrared sensors for human detection (step 512), for example. The human detection software then makes a determination as to whether anyone is approaching the user or passing by the user (step 514). If no one is approaching or passing by the user (‘no’ output of step 514), a determination is made as to whether the list containing the process IDs or names of the registered application instances is empty (step 516). If the list is empty (‘yes’ output of step 516), the process terminates. If the list is not empty (‘no’ output of step 516), the process loops back to step 508 in which the human detection software monitors the activity around the user.

Turning back to step 514, if the human detection software determines that someone is approaching or passing by the user (‘yes’ output of step 514), the human detection software reads the user-entered configuration information from the configuration file or registry (step 518). The process for entering the configuration information is described in FIG. 4.

Based on the information in the configuration file or registry, the human detection software executes an action to secure the information displayed on the user's computer monitor (step 520). The action taken is defined in the configuration file or registry and may include one of the following: minimizing all of the applications registered to be working with confidential information (step 522), closing (with an auto-save feature) all of the applications registered to be working with confidential information (step 524), switching the applications registered to be working with confidential information to the desktop background and moving another application to the foreground (step 526), or auto-locking the desktop and starting a default screen saver (step 528). The process terminates thereafter.

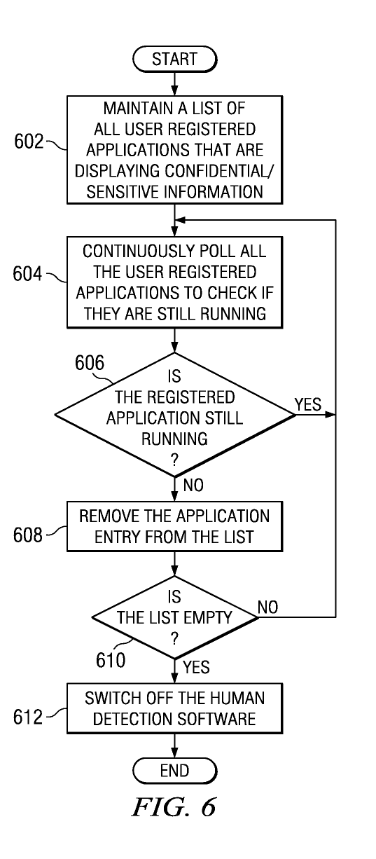

FIG. 6 is a flowchart of a process for polling the activity of registered applications in accordance with the illustrative embodiments. The process begins with maintaining the list of all user registered applications that are currently displaying confidential or sensitive information (step 602). The human detection software continuously polls all of the user registered applications to check if that they are still running (step 604). Within the polling, a determination is made as to whether a registered application is still running (step 606). If the registered application is still running (‘yes’ output of step 606), the process loops back to step 604 to continue polling the registered applications in the list. If a registered application is not running (‘no’ output of step 606), the human detection software removes the application from the list (step 608).

A determination is then made as to whether the list is empty (step 610). If the list is not empty (‘no’ output of step 610), the process loops back to step 604 to continue polling the registered applications. If the list is empty (‘yes’ output of step 610), there are no running applications displaying confidential information to monitor, and the human detection software is switched off (step 612), with the process terminating thereafter.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for automatically securing confidential information displayed on a computer, the computer implemented method comprising:
displaying confidential information in an application on a computer, wherein the application is registered in a registration list comprising a list of all applications containing confidential information;
using a monitoring device to monitor an area around a user of the computer for a possible intruder;
responsive to detecting a possible intruder, identifying an action for securing the confidential information displayed on the computer based on the applications specified in the registration list; and
executing the action.

2. The computer implemented method of claim 1, wherein the action for securing the confidential information includes one of minimizing all applications in the list, closing all applications in the list, switching all applications in the list to a background of a desktop and moving another application to a foreground of the desktop, or auto-locking the desktop and starting a default screen saver.

3. The computer implemented method of claim 1, wherein the action for securing the confidential information is defined in a configuration file or registry.

4. The computer implemented method of claim 1, wherein the action in the configuration file or registry is user-defined.

5. The computer implemented method of claim 1, wherein the monitoring device is one of a digital camera or an infrared sensor.

6. The computer implemented method of claim 1, wherein the action for securing the confidential information when a possible intruder is detected is configured by:
presenting a user interface comprising a list of actions to the user;
responsive to an action being selected by the user, storing the selected action in a configuration file or registry; and
responsive to no action being selected by the user, storing a default action in the configuration file or registry.

7. The computer implemented method of claim 1, wherein the application is registered by:
presenting a user interface to the user, wherein the user enters a process ID or process name of an instance of the application into the user interface.

8. A data processing system for automatically securing confidential information displayed on a computer, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to display confidential information in an application on a computer, wherein the application is registered in a registration list comprising a list of all applications containing confidential information, monitor an area around a user of the computer for a possible intruder using a monitoring device, identify an action for securing the confidential information displayed on the computer based on the applications specified in the registration list in response to detecting a possible intruder, and execute the action.

9. The data processing system of claim 8, wherein the action for securing the confidential information includes one of minimizing all applications in the list, closing all applications in the list, switching all applications in the list to a background of a desktop and moving another application to a foreground of the desktop, or auto-locking the desktop and starting a default screen saver.

10. The data processing system of claim 8, wherein the action for securing the confidential information is defined in a configuration file or registry.

11. The data processing system of claim 8, wherein the monitoring device is one of a digital camera or an infrared sensor.

12. The data processing system of claim 8, wherein the action for securing the confidential information when a possible intruder is detected is configured by executing the computer usable code to present a user interface comprising a list of actions to the user, storing, in response to an action being selected by the user, the selected action in a configuration file or registry, and storing, in response to no action being selected by the user, a default action in the configuration file or registry.

13. The data processing system of claim 8, wherein the application is registered by executing the computer usable code to present a user interface to the user, wherein the user enters a process ID or process name of an instance of the application into the user interface.

14. A computer program product for automatically securing confidential information displayed on a computer, the computer program product comprising:
a computer usable medium having computer usable program code tangibly embodied thereon, the computer usable program code comprising:
computer usable program code for displaying confidential information in an application on a computer, wherein the application is registered in a registration list comprising a list of all applications containing confidential information;
computer usable program code for monitoring an area around a user of the computer for a possible intruder using a monitoring device;
computer usable program code for identifying an action for securing the confidential information displayed on the computer based on the applications specified in the registration list in response to detecting a possible intruder; and
computer usable program code for executing the action.

15. The computer program product of claim 14, wherein the action for securing the confidential information includes one of computer usable program code for minimizing all applications in the list, computer usable program code for closing all applications in the list, computer usable program code for switching all applications in the list to a background of a desktop and moving another application to a foreground of the desktop, or computer usable program code for auto-locking the desktop and starting a default screen saver.

16. The computer program product of claim 14, wherein the action for securing the confidential information is defined in a configuration file or registry.

17. The computer program product of claim 14, wherein the action in the configuration file or registry is user-defined.

18. The computer program product of claim 14, wherein the monitoring device is one of a digital camera or an infrared sensor.

19. The computer program product of claim 14, wherein the action for securing the confidential information when a possible intruder is detected is configured using:
computer usable program code for presenting a user interface comprising a list of actions to the user;
computer usable program code for storing, in response to an action being selected by the user, the selected action in a configuration file or registry; and
computer usable program code for storing, in response to no action being selected by the user, a default action in the configuration file or registry.

20. The computer program product of claim 14, wherein the application is registered by:
computer usable program code for presenting a user interface to the user, wherein the user enters a process ID or process name of an instance of the application into the user interface.
